(19) United States
(12) Patent Application Publication
(10) Pub. No.: US 2026/0227733 A1
(43) Pub. Date: Aug. 6, 2026

(54) IMAGE FORMING APPARATUS

(71) Applicant: KYOCERA Document Solutions Inc., Osaka (JP)

(72) Inventors: Minoru WADA, Osaka (JP); Koichi HAYASHI, Osaka (JP); Ryo TANIGUCHI, Osaka (JP)

(73) Assignee: KYOCERA Document Solutions Inc., Osaka (JP)

(21) Appl. No.: 19/454,856

(22) Filed: Jan. 21, 2026

(30) Foreign Application Priority Data
Feb. 3, 2025 (JP) 2025-016181

(51) Int. Cl. G03G 15/00; G03G 15/01; G03G 15/02; G03G 15/04; G03G 15/06; G03G 15/08; G03G 15/09; G06K 15/02; G06K 15/12

(52) U.S. Cl. CPC G03G 15/5041; G03G 15/0115; G03G 15/0121; G03G 15/0266; G03G 15/0283; G03G 15/04027; G03G 15/065; G03G 15/0849; G03G 15/09; G06K 15/1295; G06K 15/1881; G03G 2215/0609; G06K 2215/0094

(57) ABSTRACT

An image forming apparatus includes an image forming portion, a development voltage power supply, a current detection mechanism, and a control portion. The image forming portion includes an image carrying member having a photosensitive layer on its surface and a developing device that has a developer carrying member, opposite the image carrying member, carrying two-component developer containing magnetic carrier and toner, and that attaches toner to an electrostatic latent image on the image carrying member, forming a toner image. The development voltage power supply applies a development voltage at least containing a direct-current voltage to the developer carrying member. The current detection mechanism detects, with the development voltage applied to the developer carrying member, a development current between the developer carrying member and the image carrying member. The control portion adjusts image density of a halftone image according to a development current when the halftone image is formed.

### INCORPORATION BY REFERENCE

This application is based on and claims the benefit of priority from Japanese Patent Application No. 2025-016181 filed on Feb. 3, 2025, the contents of which are hereby incorporated by reference.

### BACKGROUND

The present disclosure relates to an image forming apparatus such as a copier, a printer, a facsimile machine, or a multifunction peripheral with the functions of all of them and, in particular, to an image forming apparatus employing a two-component development method that uses two-component developer containing toner and carrier.

A typical process in image forming apparatuses employing an electrophotographic process is as follows. A photosensitive layer on the surface of a photosensitive drum (image carrying member) is electrostatically charged to a predetermined surface potential (the same polarity as that of electrostatically charged toner) by a charging device and then an electrostatic latent image on the photosensitive drum is formed by an exposure device. The formed electrostatic latent image is visualized with toner in a developing device. The toner image is transferred to a recording medium passing through a nip portion (transfer nip portion) between the photosensitive drum and a transferring member in contact with it, and is then subjected to fixing.

According to a known technology, images are adjusted using a development current that passes between the photosensitive drum and the development roller (developer carrying member).

### SUMMARY

According to one aspect of the present disclosure, an image forming apparatus includes an image forming portion, a development voltage power supply, a current detection mechanism, and a control portion. The image forming portion includes an image carrying member having a photosensitive layer formed on its surface and a developing device having a developer carrying member that is disposed opposite the image carrying member and that carries two-component developer containing magnetic carrier and toner. The developing device attaches toner to an electrostatic latent image to form a toner image. The development voltage power supply applies a development voltage containing at least a direct-current voltage to the developer carrying member. The current detection mechanism detects a development current passing between the developer carrying member and the image carrying member when the development voltage is applied to the developer carrying member. The control portion controls the image forming portion and the development voltage power supply. The control portion detects, using the current detection mechanism, a development current when a halftone image is formed as a toner image to adjust the image density of the halftone image based on the detection result.

### BRIEF DESCRIPTION OF THE DRAWINGS

FIG. 1 is a side sectional view of the inside structure of an image forming apparatus according to one embodiment of the present disclosure.

FIG. 2 is an enlarged part view around an image forming portion, showing together the control paths in the image forming apparatus.

FIG. 3 is a schematic diagram showing a current detection mechanism connected to a photosensitive drum and a development roller.

FIG. 4 is a graph showing the correlation between a blank part current and the amount of charge on toner.

FIG. 5 is a graph showing the relationship between the rate of gradation per area of a halftone image and a development current.

FIG. 6 is a flow chart showing one example of control for the adjustment of the gradation of the halftone image in the image forming apparatus according to the embodiment.

### DETAILED DESCRIPTION

### [1. Overall Configuration of Image Forming Apparatus]

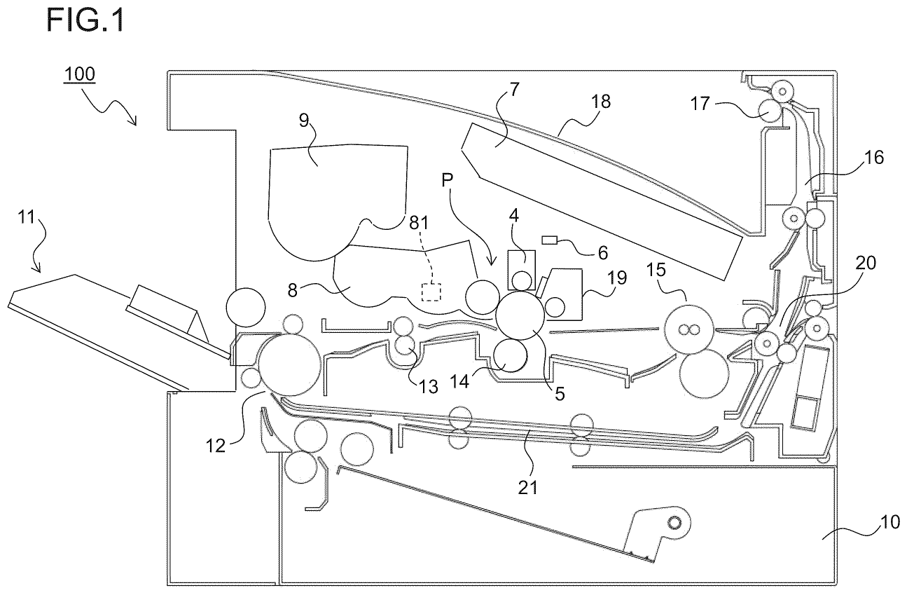

Now, an embodiment of the present disclosure will be described with reference to the accompanying drawings. FIG. 1 is a side sectional view of the inside structure of an image forming apparatus 100 according to one embodiment of the present disclosure. The image forming apparatus (here, a monochrome printer) 100 has, disposed in it, an image forming portion P that forms a monochrome image through the processes of electrostatic charging, exposure to light, image development, and image transfer. The image forming portion P has, disposed along the rotation direction (counterclockwise in FIG. 1) of a photosensitive drum 5, a charging device 4, an exposure device (laser scanning unit and the like) 7, a developing device 8, a transfer roller 14, a cleaning device 19, and an electric charge elimination device 6.

When an image is formed, the photosensitive drum 5 that rotates counterclockwise in FIG. 1 is electrostatically charged uniformly by the charging device 4. Then, with a laser beam from the exposure device 7 based on document image data, an electrostatic latent image is formed on the photosensitive drum 5. After that, toner is attached to the electrostatic latent image by the developing device 8 to form a toner image. Note that the image data is fed from a personal computer (not shown) or the like.

Toner is fed to the developing device 8 from a toner container 9. The toner concentration (T/C, mass ratio of toner to magnetic carrier) in the developing device 8 is detected by a toner concentration sensor 81 (see FIG. 1). The electric charge elimination device 6 that eliminates residual electric charge by shining charge elimination light to the surface of the photosensitive drum 5 is provided downstream of the cleaning device 19 with respect to the rotation direction of the photosensitive drum 5.

Toward the photosensitive drum 5 with the toner image formed on it as described above, a sheet (recording medium) is conveyed from a sheet feed cassette 10 or a manual sheet feed device 11 via a sheet conveyance passage 12 and a pair of registration rollers 13. The sheet passes through the nip portion (transfer nip portion) between the transfer roller 14 and the photosensitive drum 5 to have the toner image formed on the surface of the photosensitive drum 5 transferred to it. The sheet with the toner image transferred to it is separated from the photosensitive drum 5 and is conveyed to a fixing device 15 to have the toner image fixed to it. The sheet having passed through the fixing device 15 is conveyed to an upper part of the apparatus along a sheet conveyance passage 16 and is discharged to a discharge tray 18 by a pair of discharge rollers 17 if an image is formed on one side of the sheet (in simplex printing).

On the other hand, if images are formed on both sides of the sheet (in duplex printing), after the trailing edge of the sheet passes through a branching portion 20 in the sheet conveyance passage 16, its conveyance direction is reversed. The sheet is then sorted to a reverse conveyance passage 21 branching off from the branching portion 20 and is conveyed by the pair of registration rollers 13 again with the image side reversed. Then the next toner image formed on the photosensitive drum 5 is transferred by the transfer roller 14 to the side of the sheet having no image formed on it yet. The sheet having the toner image transferred to it is conveyed to the fixing device 15 to have the toner image fixed to it and is then discharged to the discharge tray 18 by the pair of discharge rollers 17.

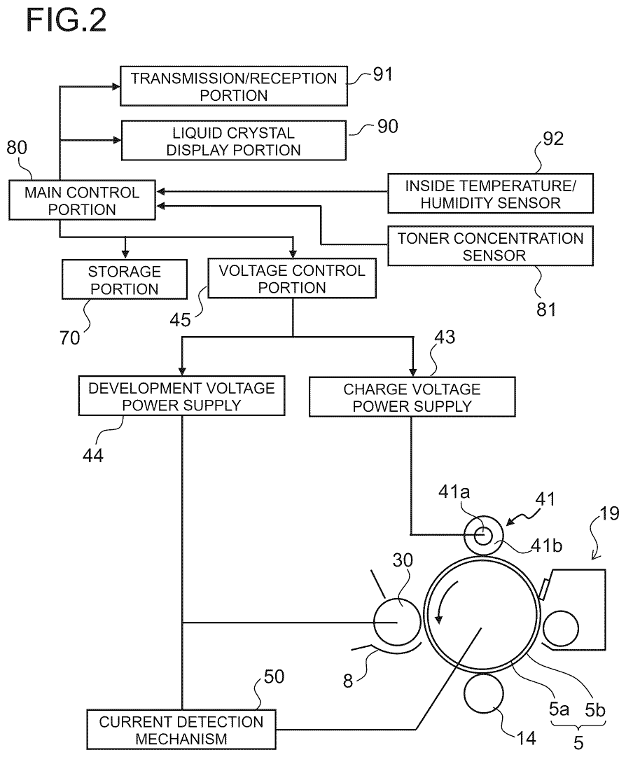

FIG. 2 is an enlarged part view around the image forming portion P, showing together the control paths in the image forming apparatus 100. The charging device 4 includes a charging roller 41 that is disposed in contact with the photosensitive drum 5 and that electrostatically charges the photosensitive drum 5.

The charging roller 41 is formed by coating a metal core 41a with a conductive layer 41b and is disposed in contact with the photosensitive drum 5. The conductive layer 41b is ion-conductive with an ion conductive agent blended in cross-linked rubber. Used as the cross-linked rubber is epichlorohydrin rubber or the like. Used as the ion conductive agent is a quaternary ammonium salt, a boron salt, or the like.

The photosensitive drum 5 has, for example, an organic photosensitive layer (OPC) 5b, which is a positively chargeable photoconductor, formed as a photosensitive layer on the surface of a drum base tube (conductive base) 5a made of aluminum. The photosensitive drum 5 is driven to rotate about a shaft at a constant speed by a drum driving portion (not shown).

As shown in FIG. 2, as the photosensitive drum 5 rotates counterclockwise, the charging roller 41 in contact with the surface of the photosensitive drum 5 follows it to rotate clockwise. Meanwhile, a predetermined charging voltage is applied to the charging roller 41 to electrostatically charge the surface of the photosensitive drum 5 uniformly.

The charging roller 41 is connected to a charge voltage power supply 43 that produces a charging voltage that has an alternating-current voltage superposed on a direct-current voltage. The charge voltage power supply 43 includes an alternating-current constant voltage power supply and a direct-current constant voltage power supply (neither is shown). The alternating-current constant voltage power supply outputs an alternating-current voltage with a sine wave produced from a low direct-current voltage modulated into pulses using a step-up transformer (not shown). The direct-current constant voltage power supply outputs a direct-current voltage produced by rectifying an alternating-current voltage with a sine wave produced from a low direct-current voltage modulated into pulses using a step-up transformer.

The developing device 8 includes a development roller 30 that is disposed opposite the photosensitive drum 5 and that carries two-component developer containing magnetic carrier and toner (hereinafter, referred to simply as developer). The development roller 30 is connected to a development voltage power supply 44 that produces a development voltage that has an alternating-current voltage superposed on a direct-current voltage. The development voltage power supply 44 has a similar configuration to the charge voltage power supply 43. A predetermined development voltage is applied to the development roller 30, so that the toner in the developer carried by the development roller 30 is attracted to the surface of the photosensitive drum 5 to develop the electrostatic latent image into a toner image. A current detection mechanism 50 detects a development current that passes between the development roller 30 and the photosensitive drum 5.

Next, the control system of the image forming apparatus 100 will be described with reference to FIG. 2. The image forming apparatus 100 includes a main control portion 80 comprising a CPU and the like. The main control portion 80 is connected to a storage portion 70 comprising a ROM, a RAM, and the like. The main control portion 80 controls based on programs and data for control stored in the storage portion 70 different portions of the image forming apparatus 100 (such as the charging device 4, the electric charge elimination device 6, the exposure device 7, the developing device 8, the transfer roller 14, the cleaning device 19, the fixing device 15, the charge voltage power supply 43, the development voltage power supply 44, a voltage control portion 45, the current detection mechanism 50).

The voltage control portion 45 controls the charge voltage power supply 43 that applies an alternative voltage to the charging roller 41 and the development voltage power supply 44 that applies a development voltage to the development roller 30. Note that the voltage control portion 45 can be configured as a control program stored in the storage portion 70.

The main control portion 80 is connected to a liquid crystal display portion 90 and a transmission/reception portion 91. The liquid crystal display portion 90 functions as a touch panel for a user to make various settings for the image forming apparatus 100 and also displays the condition of the image forming apparatus 100, the status of image formation, the number of sheets printed, and the like. The transmission/reception portion 91 externally communicates via a telephone or Internet network.

An inside temperature/humidity sensor 92 senses the temperature and humidity in the image forming apparatus 100, in particular around the developing device 8. The sensing result is transmitted to the main control portion 80.

### [2. Configuration of Current Detection Mechanism]

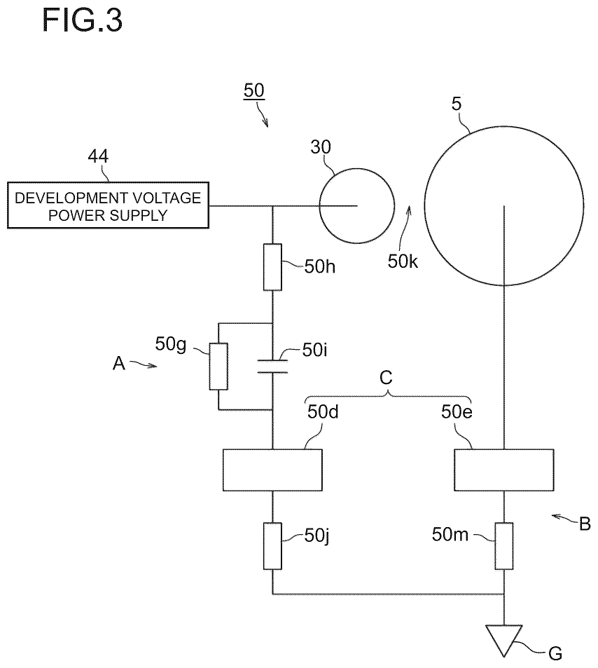

FIG. 3 is a schematic diagram showing the current detection mechanism 50 connected to the photosensitive drum 5 and the development roller 30. The current detection mechanism 50 has a first connecting part A, a second connecting part B, and a current detection portion C.

The first and second connecting parts A and B are each connected in series with the development voltage power supply 44. The first and second connecting parts A and B are each connected to a ground point (ground) G. The development voltage power supply 44 applies a development voltage to the development roller 30, so that an electric current passes through each of the first and second connecting parts A and B.

The current detection portion C has a first current detection portion 50d and a second current detection portion 50e. The first current detection portion 50d detects an electric current passing through the first connecting part A. The second current detection portion 50e detects an electric current passing through the second connecting part B. The current detection portion C recognizes the value obtained by subtracting the detection value of the first current detection portion 50d from the detection value of the second current detection portion 50e as the development current passing through an image part (hereinafter referred to as the image part current). The current detection portion C recognizes the detection value of the first current detection portion 50d (or the detection value of the second current detection portion 50e) as the development current passing through a non-image part (hereinafter referred to as the blank part current). The image part current and the blank part current will be described later.

The first connecting part A has a first resistor 50g, a second resistor 50h, a capacitor 50i, and a third resistor 50j. The second resistor 50h, the capacitor 50i, the first current detection portion 50d, and the third resistor 50j are connected in series in this order with respect to the development voltage power supply 44. The third resistor 50j is connected to the ground point G.

The first resistor 50g is connected in parallel with the capacitor 50i. The first resistor 50g is connected in series with the second resistor 50h, the first current detection portion 50d, and the third resistor 50j. The first resistor 50g is disposed between the second resistor 50h and the first current detection portion 50d.

The second connecting part B has a development region 50k and a fourth resistor 50m. The development region 50k is a region located between the development roller 30 and the photosensitive drum 5.

The development region 50k, the second current detection portion 50e, and the fourth resistor 50m are connected in series in this order with respect to the development voltage power supply 44. The fourth resistor 50m is connected to the ground point G.

The development voltage power supply 44 applies a development voltage of the same polarity (here, positive) as toner to the development roller 30, so that a potential difference is produced between the development roller 30 and the photosensitive drum 5 (hereinafter referred to as the DS gap). The electrostatically charged toner moves across the development region 50k between the development roller 30 and the photosensitive drum 5, so that the toner carried by the development roller 30 is fed to the photosensitive drum 5. This develops the electrostatic latent image formed on the surface of the photosensitive drum 5 into a toner image. As a result of the electrostatically charged toner moving between the development roller 30 and the photosensitive drum 5, an electric current passes across the development region 50k.

When toner moves between the development roller 30 and the photosensitive drum 5, since the development region 50k is filled with developer, the toner moves through the developer. Thus, in addition to a capacitance, a resistance ascribable to the developer is present between the development roller 30 and the photosensitive drum 5. The capacitance here is the capacitance between the development roller 30 and the photosensitive drum 5.

The image part current denotes the current generated by toner moving between the development roller 30 and the photosensitive drum 5 (hereinafter referred to as the DS gap). The image part current denotes the current generated solely by toner moving across the DS gap and is a current value observed when the electric current passing across the DS gap is not affected by the capacitance and the resistance. The image part current has a correlation with the amount of toner moving across the DS gap (moving toner) and has a value corresponding to the amount of moving toner. Specifically, as the amount of moving toner increases, the image part current increases.

The blank part current denotes the current passing across the DS gap when no toner moves across the DS gap. Specifically, when the development roller 30 faces a non-image part (blank part) of the photosensitive drum 5, the development region 50k is filled with carrier (magnetic brush) to form a circuit that connects the first and second connecting parts A and B in a ring form. The current generated in this state by the toner moving through the magnetic brush toward the development roller 30 is the blank part current (development current in the non-image part), and the detection value of the first current detection portion 50d is equal to the detection value of the second current detection portion 50e.

With the current detection mechanism 50 shown in FIG. 3, which is provided with the capacitor 50i disposed in parallel with the development region 50k between the development roller 30 and the photosensitive drum 5 and the first and second resistors 50g and 50h connected in parallel and in series with the capacitor 50i, the image part current and the blank part current can be accurately detected.

### [3. Adjustment of Image Density of Halftone Image Based on Development Current]

A description will now be given of, as a distinctive feature according to the present disclosure, a method of adjusting the image density of a halftone image based on the development current. In the embodiment, the development current is measured when a halftone image is developed to adjust the image density of the halftone image based on the measurement result.

The development current is the amount of electric charge that moves per unit time, and thus, let I be the development current, then I=Q/t. Since (development current)=(amount of charge on toner)×(amount of toner attached), let Q/M be the amount of charge on toner, then (amount of toner attached)=(development current)/(amount of charge on toner)=(Q/t)/(Q/M)=M/t. To adjust image density based on the development current, use is made of a method involving calculating, from the development current I=Q/t and the estimated value Q/M of the amount of charge on toner, the amount of toner attached M/t for use in the adjustment of image density.

Various methods are practiced of estimating the amount of charge on toner Q/M. Examples include a method of estimating the amount of charge on toner based on a development current passing when a reference image is formed and the image density of the reference image sensed by an image density sensor. The image forming apparatus 100 according to the embodiment, however, incorporates no image density sensor, and thus cannot employ a method using an image density sensor. Examples of methods of estimating the amount of charge on toner without use of an image density sensor include a method of estimating the amount of charge on toner Q/M from the correlation between a blank part current and the amount of charge on toner.

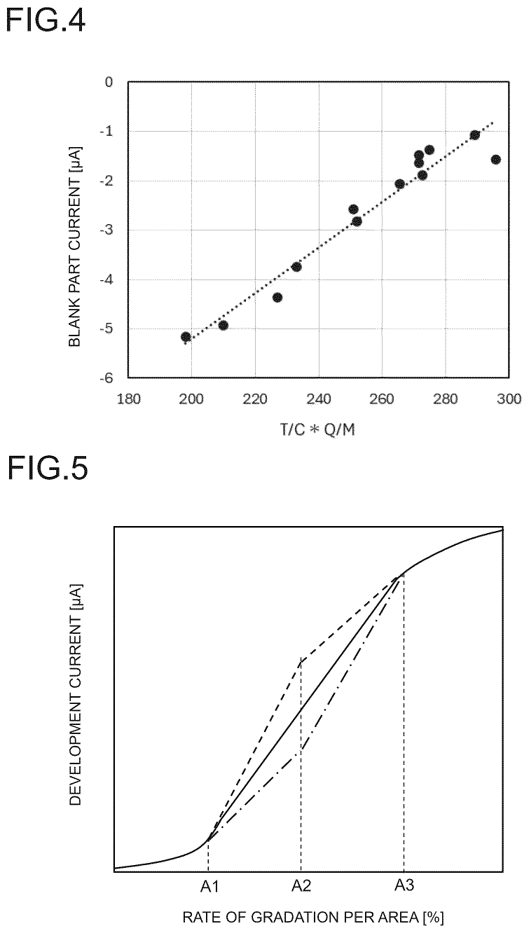

FIG. 4 is a graph showing the correlation between the blank part current and the amount of charge on toner. FIG. 4 is a plot of the blank part current I observed as T/C*Q/M is changed, with the product (T/C*Q/M) of toner concentration T/C and the amount of charge on toner Q/M taken along the horizontal axis and with the blank part current I taken along the vertical axis. FIG. 4 reveals a positive correlation between the blank part current and the amount of charge on toner.

The relationship shown in FIG. 4 is experimentally obtained previously and is stored in the storage portion 70. Then, the amount of charge on toner Q/M is estimated using the development current I (=Q/t) passing when a halftone image is formed and the toner concentration T/C in the developing device 8 sensed by the toner concentration sensor 81 (see FIG. 2). Since the amount of toner attached is represented by (Q/t)/(Q/M)=M/t, the amount of toner attached M/t can be calculated using the estimated value Q/M of the amount of charge on toner to adjust the image density of the halftone image.

Examples of methods of adjusting image density include adjusting the development voltage (direct-current voltage, alternating-current voltage), adjusting the amount of light from the exposure device 7, and adjusting the charging voltage applied to the charging roller 41.

Next, a description will be given of a method of adjusting the gradation of the halftone image using the development current. Usable as the method of adjusting gradation is a method that involves developing a halftone image with the rate of gradation per area changed by three levels or more and adjusting the development currents passing during the development of the halftone images such that they exhibit a linear relationship.

FIG. 5 is a graph showing the relationship between the rate of gradation per area of the halftone image and the development current. As shown in FIG. 5, as the rate of gradation per area increases, the development current increases. Specifically, in a range where the rate of gradation per area is designated (between A1 and A3 in FIG. 5), the increase of the amount of development current and the rate of gradation per area exhibit a linear relationship. In the range where the increase of the amount of development current and the rate of gradation per area exhibit a linear relationship, halftone image are developed with the rate of gradation per area changed by three levels or more. Then, the development currents passing during the development of the halftone images are controlled so as to fall on a straight line. This allows adjustment of the image density of the halftone image that does not rely on an estimated value of the amount of charge on toner.

For example, if the gradient of the development current is steep between A1 and A2 and gentle between A2 and A3 (indicated by a broken line in FIG. 5), image density is too high compared with a target value. Thus, a development condition is adjusted so as to lower the image density. This can be achieved, for example, by reducing a direct-current voltage Vdc in the development voltage, reducing the amount of light from the exposure device 7, or increasing the charging voltage applied to the charging roller 41.

On the other hand, if the gradient of the development current is gentle between A1 and A2 and steep between A2 and A3 (indicated by a chain line in FIG. 5), image density is too low compared with the target value. Thus, a development condition is adjusted so as to raise the image density. This can be achieved, for example, by increasing a direct-current voltage Vdc in the development voltage, increasing the amount of light from the exposure device 7, or reducing the charging voltage applied to the charging roller 41.

As a method of changing the rate of gradation per area of the halftone image by three levels or more, the image pattern (the arrangement or number of dots) of the halftone image is changed to set three levels or more of the rate of gradation per area. Then the rate of gradation per area is adjusted based on the result obtained by developing the halftone images of the set levels under the same development conditions.

In addition, as shown in FIG. 5, the relationship between the rate of gradation per area and the development current deviates off the straight line in the region where the rate of gradation per area is less than A1 and in the region where it is more than A3. To accurately adjust the gradation of the halftone image, it is preferable that the three levels of the rate of gradation per area spread across as broad a range as possible within the range where the relationship between the rate of gradation per area and the development current is linear. That is, as described above, it is preferable to change the rate of gradation per area by three levels or more such that these include the minimum value (A1) and the maximum value (A3) within the range where the relationship between the rate of gradation per area and the development current is linear. The range where the relationship between the rate of gradation per area and the development current is linear is experimentally or otherwise determined previously and is stored in the storage portion 70.

The gradation of the halftone image can be adjusted by any other method. For example, while the direct-current voltage Vdc in the development voltage is changed by a plurality of levels, halftone images with the same rate of gradation per area are formed and the development current I during the formation of the halftone image is measured; using formula (1) below, which represents the relationship between the development current I and the development voltage (direct-current voltage) Vdc, the direct-current voltage Vdc is determined at which the rate of gradation per area equals the target value to adjust the image density of a halftone image.

$$I = Q / t = c * Vdc + d \qquad ( 1 )$$

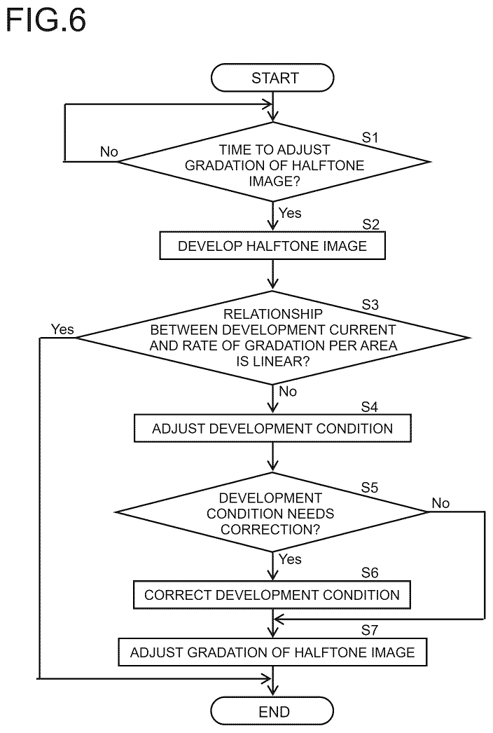

FIG. 6 is a flow chart showing one example of control for the adjustment of the gradation of a halftone image in the image forming apparatus 100 according to the embodiment. Along the steps in FIG. 6, with reference also to FIGS. 1 to 5 as necessary, a procedure for adjusting the gradation of the halftone image will be described in detail. Note that FIG. 6 illustrates a case where the gradation of a halftone image is adjusted.

First, the main control portion 80 checks whether the time has come to adjust the gradation of a halftone image (step S1). Examples of the time to adjust gradation include when the cumulated number of printed sheets after the previous adjustment of image density has reached a predetermined number, when the image forming apparatus 100 is switched on, and when it recovers from a power-save (sleep) mode. If the time to adjust gradation has come (Yes in step S1), within the range where the increase of the amount of development current and the rate of gradation per area exhibit a linear relationship, halftone images are developed so as to have three levels of the rate of gradation per area (step S2).

Next, the main control portion 80 checks whether the relationship between the development current measured during the development of the halftone images and the rate of gradation per area is linear (step S3). If the relationship between the development current and the rate of gradation per area is not linear (No in step S3), the main control portion 80 adjusts a development condition such that the relationship between the development current and the rate of gradation per area is linear (step S4). Specifically, the main control portion 80 determines the development condition, such as the direct-current voltage Vdc or the alternating-current voltage Vac in the development voltage, the amount of light emitted from the exposure device 7, or the charging voltage, so that the relationship between the development current and the rate of gradation per area is linear.

Then, the main control portion 80 checks whether the development condition needs correction based on the sensing results of the toner concentration sensor 81 and the inside temperature/humidity sensor 92, the cumulative printing rate, and the total operating time of the developing device 8 (step S5). If the development condition needs correction (Yes in step S5), the main control portion 80 corrects the development condition determined in step S4 (step S6) and adjusts the gradation of the halftone image using the corrected development condition (step S7).

On the other hand, if the development condition needs no correction (No in step S5), the main control portion 80 adjusts the gradation of the halftone image using the development condition determined in step S4 (step S7). By contrast, if in step S3 the relationship between the development current and the rate of gradation per area is linear (Yes in step S3), the procedure ends without the adjustment of the development condition.

As shown in FIG. 6, adjusting the gradation of the halftone image using the development current during the development of the halftone image helps maintain an appropriate gradation of the halftone image for a long period of time; it also eliminates the need to measure image density using an image density sensor and thus allows accurate adjustment of the gradation of the halftone image even in an image forming apparatus incorporating no image density sensor.

When the gradation of the halftone image is adjusted, consideration can be given to, in addition to the measurement result of the development current, the sensing results of the toner concentration sensor 81 and the inside temperature/humidity sensor 92. This helps further enhance the stability of gradation.

The present disclosure is not limited to the embodiment described above, and thus any modification can be made without departing from the spirit of the present disclosure. For example, the current detection mechanism 50 is not limited to the configuration of the embodiment shown in FIG. 3; any other configuration can be used that can accurately measure the development current.

In addition, while the above embodiment deals with a configuration that uses positively chargeable toner, the present disclosure is equally applicable to a configuration that uses negatively chargeable toner. When negatively chargeable toner is used, the polarities of the development side and the collection side are reversed compared with the case where the positively chargeable toner is used; specifically, the development side is negative, and the collection side is positive.

While the above embodiment takes a monochrome printer as shown in FIG. 1 as an example of the image forming apparatus 100, it can be, instead of the monochrome printer, any image forming apparatus such as a monochrome or color copier, a digital multifunction peripheral, a color printer, and a facsimile machine.

To perform calibration to correct image density and color misregistration, a color copier or a color printer requires an image density sensor to sense the density of a reference image. To assist typical calibration using an image density sensor, the adjustment of image density or the gradation of a halftone image using a development current according to the embodiment is performed at an occasion different from during calibration. This helps reduce the time for adjustment of image density on and allows efficient operation of a color copier or a color printer.

The present disclosure finds applications in image forming apparatuses including a developing device employing a two-component development method that uses two-component developer containing toner and carrier. With the present disclosure, it is possible to provide an image forming apparatus that, while employing a two-component development method, can easily stabilize image density of a halftone image at lower cost.

What is claimed is:

1. An image forming apparatus comprising:
an image forming portion including:
an image carrying member having a photosensitive layer formed on a surface thereof; and
a developing device having a developer carrying member that is disposed opposite the image carrying member and that carries two-component developer containing magnetic carrier and toner, the developing device attaching the toner to an electrostatic latent image formed on the image carrying member to form a toner image;
a development voltage power supply that applies a development voltage at least containing a direct-current voltage to the developer carrying member;
a current detection mechanism that detects, when the development voltage is applied to the developer carrying member, a development current passing between the developer carrying member and the image carrying member; and
a control portion that controls the image forming portion and the development voltage power supply,
wherein
the control portion detects, using the current detection mechanism, the development current when a halftone image is formed as the toner image and adjusts image density of the halftone image based on a detection result.

2. The image forming apparatus according to claim 1, wherein
the control portion adjusts gradation of the halftone image based on the development current when a plurality of the halftone images are formed with different levels of rate of gradation per area.

3. The image forming apparatus according to claim 2, wherein
the control portion adjusts the gradation of the halftone image such that a relationship between the rate of gradation per area and the development current when the plurality of the halftone images are formed is linear.

4. The image forming apparatus according to claim 1 further comprising:
a charging device that charges the surface of the image carrying member;
an exposure device that shines light to the surface of the image carrying member charged by the charging device to form the electrostatic latent image through attenuation of electric charge; and
a charge voltage power supply that applies a charging voltage to the charging device,
wherein
the control portion adjusts the image density and the gradation of the halftone image by changing at least one of the development voltage, the charging voltage, and an amount of light emitted from the exposure device.

5. The image forming apparatus according to claim 4, wherein
the control portion calculates an amount of the toner attached based on the development current and an estimated result of an amount of charge on the toner.

6. The image forming apparatus according to claim 5, wherein
the control portion detects, using the current detection mechanism, a blank part current passing between the developer carrying member and a non-image part of the image carrying member and estimates the amount of charge on the toner based on the blank part current detected.

7. The image forming apparatus according to claim 1 further comprising:
a temperature/humidity sensor that senses temperature/humidity inside or outside the image forming apparatus; and
a toner concentration sensor that senses a proportion of the toner to the magnetic carrier in the developing device,
wherein
the control portion adjusts the image density of the halftone image with consideration given also to at least one of a sensing result of the temperature/humidity sensor, a sensing result of the toner concentration sensor, a cumulative printing rate of the toner image, and a total operating time of the developing device.

8. The image forming apparatus according to claim 1 further comprising:
an image density sensor that senses an image density of the toner image formed on the image carrying member to enable the image forming apparatus to perform calibration for adjustment of the image density of the toner image based on a sensing result of the image density sensor,
wherein
the control portion detects the development current using the current detection mechanism at an occasion different from the calibration to auxiliary adjust the image density of the halftone image based on a detection result.

9. The image forming apparatus according to claim 8 comprising:
a plurality of the image forming portions corresponding to the toner of different colors.
